(19) United States
(12) Patent Application Publication
(10) Pub. No.: US 2006/0184576 A1
(43) Pub. Date: Aug. 17, 2006

(54) System and method for extensible metadata architecture for digital images

(75) Inventors: David Albert, Woodinville, WA (US); Frank Alva Krueger, Bothell, WA (US); Rajat Goel, Seattle, WA (US); Peter A. Gurevich, Woodinville, WA (US); Anthony John Rolls Hodsdon, Seattle, WA (US); Radu C. Magarint, Bothell, WA (US); Thomas W. Olsen, Issaquah, WA (US); Rahul V. Patil, Redmond, WA (US); Cyra S. Richardson, Bellevue, WA (US); Robert Earl Sinclair II, Sammamish, WA (US); Richard S. Turner JR., Woodinville, WA (US); Eric Vandenberg, Seattle, WA (US); Robert A. Wlodarczyk, Redmond, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 11/062,267

(22) Filed: Feb. 17, 2005

(51) Int. Cl. G06F 17/00

(52) U.S. Cl. 707/104.1

(57) ABSTRACT

An improved system and method for an extensible metadata architecture for digital images is provided. Executable software code may be operably coupled to a metadata query reader and a metadata query writer for requesting operations for manipulating metadata in an image file. The metadata query reader may be operably coupled to a decoder having a block reader for identifying metadata blocks in an image file and associating a metadata reader with each metadata block. Each metadata reader may then enumerate the metadata in the metadata block associated with that metadata reader. The metadata query writer may be operably coupled to an encoder having a block writer for associating a metadata writer with each metadata block to be written to an image file. Each metadata writer may then write metadata in the metadata block associated with that metadata writer.

### CROSS-REFERENCE TO RELATED APPLICATIONS

The present invention is related to the following copending United States patent application filed concurrently herewith, assigned to the assignee of the present invention, and hereby incorporated by reference in its entirety, “System and Method for Extensible Metadata Architecture For Digital Images Using In-place Editing,” Attorney Docket No. 5271.

### FIELD OF THE INVENTION

The invention relates generally to computer systems, and more particularly to an improved system and method for an extensible metadata architecture for digital images.

### BACKGROUND OF THE INVENTION

Image formats for digital images continue to evolve as the popularity of digital images grows. As applications for digital images expand, extensions to metadata formats used to describe digital images emerge regularly in evolving industry standards for specific image formats. However, existing implementations of codecs used to encode and decode an image format typically have fixed metadata formats for standard image types. For instance, one common approach for including metadata within an image file is to set aside a block of data for the metadata. When additional metadata is introduced in an image format, the implementation of an encoder and decoder in a codec built for that image format must be updated to handle the additional metadata. Unfortunately, the process for updating a codec is expensive and time consuming.

Furthermore, existing implementations of codecs may not provide support for third party metadata formats. Moreover, the tight coupling and dependencies between a codec and a particular image format prevent easy reuse of executable code for encoding and decoding metadata for different image formats that may be included in a single image file with multiple images. What is needed is a way for a computer system to easily adapt to the introduction of additional metadata for image formats and without having to release a new implementation of a codec in order to support additional metadata types for an image format. Such a system and method should also be able to support applications using third party implementations of image formats and extensions to existing image formats.

### SUMMARY OF THE INVENTION

Briefly, the present invention provides an improved system and method for an extensible metadata architecture for digital images. To this end, executable software code may be operably coupled to a metadata query reader and a metadata query writer for requesting operations for manipulating metadata in an image file. The metadata query reader may be operably coupled to a decoder having a block reader for identifying metadata blocks in an image file and associating a metadata reader with each metadata block. Each metadata reader may then enumerate the metadata in the metadata block associated with that metadata reader. The metadata query writer may be operably coupled to an encoder having a block writer for associating a metadata writer with each metadata block to be written to an image file. Each metadata writer may then write metadata in the metadata block associated with that metadata writer.

Each metadata reader and each metadata writer may be operably coupled to an image file that may include metadata blocks with one or more nested metadata blocks. In one embodiment, a metadata block may include a nested metadata block for a different type of image. Each nested metadata blocks may also include, in turn, one or more nested metadata blocks so that metadata blocks may be nested for any number of levels. Correspondingly, a metadata reader and/or a metadata writer may be associated with each metadata block within a hierarchy of nested metadata blocks.

Furthermore, the system and method support a query language so that the metadata query reader and the metadata query writer may receive a query string. If the query string specified does not correspond to a fully qualified location, then the request may be resolved by a policy component which may be operably coupled to the metadata query reader and the metadata query writer. The policy component may resolve the query string by mapping the query string to a specific location within the metadata hierarchy.

Advantageously, the system and method allow the addition of new metadata types to be added to image files, and new metadata readers and writers may be easily added for decoding and encoding metadata in an image file associated with the new metadata types. The framework provided may accordingly support third party implementations of image formats and extensions to existing image formats. Moreover, enumerated metadata items may be easily changed using a fast metadata encoder to perform in-place editing of the metadata without the need to use a separate image stream for writing modified metadata to an image file. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components in one embodiment of an extensible metadata architecture for digital images, in accordance with an aspect of the present invention;

FIG. 3 is a flowchart generally representing exemplary steps undertaken in one embodiment for reading metadata in an image file, in accordance with an aspect of the present invention;

FIG. 4 is a flowchart generally representing exemplary steps undertaken in one embodiment for writing metadata in an image file, in accordance with an aspect of the present invention;

FIG. 5 is a block diagram generally representing an exemplary architecture of system components in one embodiment of an extensible metadata architecture for fast writing of metadata in an image file, in accordance with an aspect of the present invention; and

FIG. 6 is flowchart generally representing exemplary steps undertaken in one embodiment for fast writing of metadata in an image file, in accordance with an aspect of the present invention.

### DETAILED DESCRIPTION

Exemplary Operating Environment

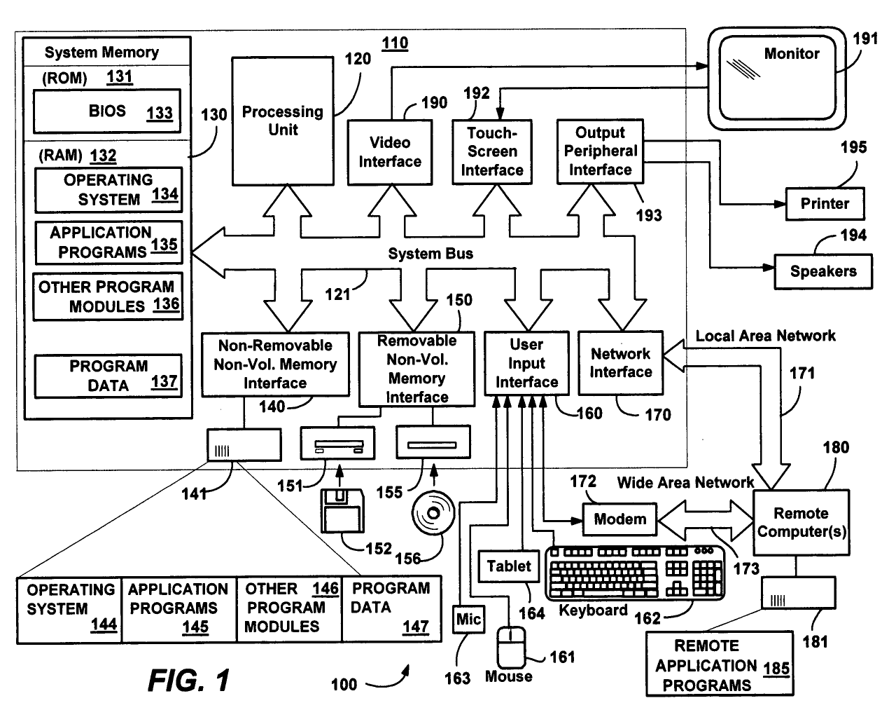

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, headless servers, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable, memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or other devices including a device that contains a biometric sensor, environmental sensor, position sensor, or other type of sensor. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like connected to the system bus 121 via touch screen interface 192. Note that the monitor and/or touch screen panel can be physically coupled to a housing in which the computing device 110 is incorporated, such as in a tablet-type personal computer. In addition, computers such as the computing device 110 may also include other peripheral output devices such as speakers 194 and printer 195, which may be connected through an output peripheral interface 193 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Extensible Metadata Architecture for Digital Images

The present invention is generally directed towards a system and method for an extensible metadata architecture for digital images. Metadata, as used herein, may mean data that may describe attributes of multimedia content, such as an image, including, without limitation, author, creation data, width, height, shutter speed, and so forth. Multimedia content may generally mean any type of video content including without limitation a digital image or digital video, any type of audio content including without limitation digital music, or a combination of video and audio content. The system and method may advantageously allow the addition of new metadata types to be added to image files, and new metadata readers and writers may be easily added for decoding and encoding metadata in an image file associated with the new metadata types. The framework provided may accordingly support third party implementations of image formats and extensions to existing image formats. To do so, the present invention may provide one or more metadata block readers that may be associated with a metadata block within an image file. A metadata block, as used herein, may mean a collection of one or more metadata items that may or may not be related. For example, some imaging formats may specify a collection of metadata items each represented by a keyword and value pair.

The present invention may also provide one or more metadata block writers that may be associated with a metadata block to be written to an image file. As will be seen, enumerated metadata items may be easily changed using a fast metadata encoder to perform in-place editing of the metadata without the need to use a separate image stream for writing modified metadata to an image file. As will be understood, the various block diagrams, flow charts and scenarios described herein are only examples, and there are many other scenarios to which the present invention will apply.

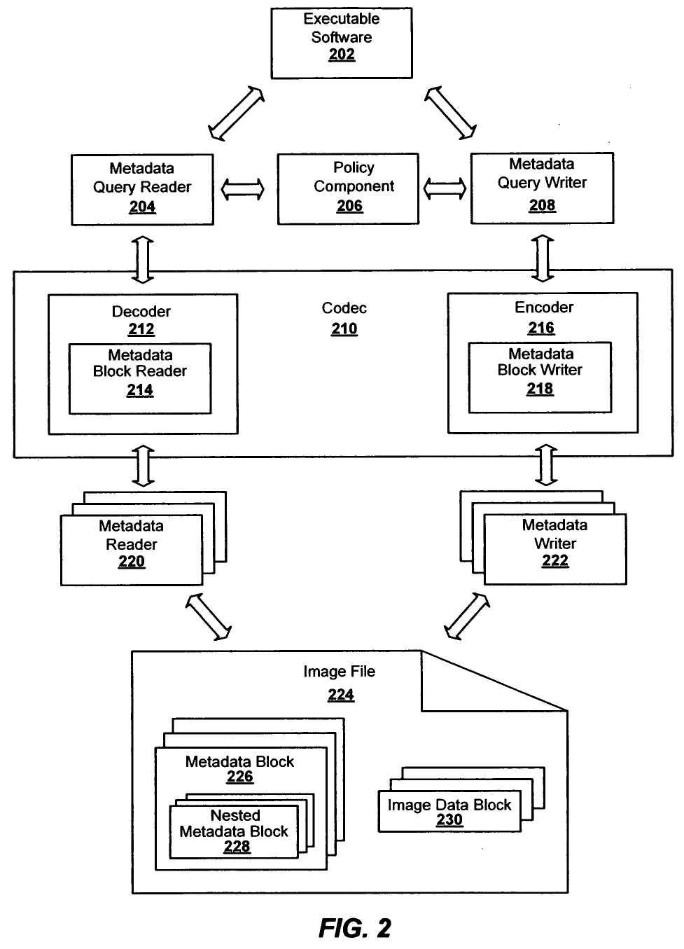

Turning to FIG. 2 of the drawings, there is shown a block diagram generally representing an exemplary architecture of system components in one embodiment of an extensible metadata architecure for digital images. Those skilled in the art will appreciate that the functionality implemented within the blocks illustrated in the diagram may be implemented as separate components or the functionality of several or all of the blocks may be implemented within a single component. As an example, the functionality of a decoder 212 may be implemented in a separate component from codec 210.

Executable software 202 shown in FIG. 2 may perform any number of operations with an image file, including reading metadata from and writing metadata to an image file. The executable software 202 may be operably coupled to a metadata query reader 204 for requesting metadata to be read from an image file and may be operably coupled to a metadata query writer 208 for requesting metadata to be written to an image file. In one embodiment, the metadata query reader 204 may provide a MetaDataQueryReader application programming interface (API) that may be invoked by the executable software 202 to request metadata to be read from an image file using a query language and the metadata query writer 208 may provide a MetaDataQueryWriter API that may be invoked by the executable software 202 to request metadata to be written to an image file using a query language. A policy component 206 may also be operably coupled to the metadata query reader 204 and to the metadata query writer 208 for resolving non-fully qualified queries for a metadata item. The executable software 202, the metadata query reader 204, the metadata query writer 208 and the policy component 206 may each be any executable software code including an application program or application component, a component of a linked library, an object, and so forth. The metadata query reader 204 may also be operably coupled to a decoder 212 of a codec 210 and the metadata query writer 208 may also be operably coupled to an encoder 216 of the codec 210.

There may be a codec, such as codec 210, provided for each type of image file supported by the computer system. For example, there may be a codec for GIF, JPEG, PNG, TIFF, and other image file formats. Each codec may include a decoder 212 for decoding an image and an encoder 216 for encoding an image. Decoder 212 may include a metadata block reader 214 that may be operably coupled to one or more metadata readers 220. The metadata block reader 214 may identify recognizable metadata blocks 226 within an image file 224. Each metadata reader 220 may then provide functionality for parsing a type of metadata block recognized within an image file. In one embodiment, a decoder may thus read metadata in an image file by using the metadata block reader to identify recognizable metadata blocks within the image file and then may use the same or a different metadata reader to decipher the metadata items in each metadata block. In various embodiments, a decoder may also use one or more metadata readers to parse a metadata block 226 that may include nested metadata blocks 228. Either the same or a different metadata reader may be used to decipher the metadata items in each nested metadata block. In this way, a decoder may provide metadata items requested by a metadata query reader for an executable.

And encoder 216 may include a metadata block writer 218 that may be operably coupled to one or more metadata writers 222. The metadata block writer 218 may identify and add a metadata writer 222 for each metadata block 226 to be written within an image file 224. Each metadata writer 222 may then provide functionality for writing metadata items for a type of metadata block to be written within an image file. In one embodiment, an encoder may thus write metadata in an image file by using the metadata block writer to identify and add metadata writers for each metadata block to be written in the image file. Thus, an encoder may write metadata items requested by an executable using a metadata query writer.

The metadata reader 220 and the metadata writer 222 may be operably coupled to an image file 224 that may include metadata blocks 226 and image data blocks 230. A metadata block 226 may include one or more nested metadata blocks 228. In one embodiment, a metadata block may include a nested metadata block for a different type of image than the metadata block. Each nested metadata blocks may also include, in turn, one or more nested metadata blocks so that metadata blocks may be nested for any number of levels. Correspondingly, a metadata reader may be associated with each metadata block within a hierarchy of nested metadata blocks.

Those skilled in the art will appreciate that the metadata architecture shown in FIG. 2 may be but one exemplary embodiment for practicing the present invention and that other computing system configurations may be used to implement the present invention. For example, a decoder may be provided without an encoder for an application that may read metadata information in an image file but yet not write metadata information to an image file. As another example, a fast metadata writer may be implemented by using a metadata block reader to read metadata blocks from an image file and then using a metadata block writer to perform in-place editing of metadata items in a metadata block for writing back to the image file. In yet another example, executable software code may instantiate a metadata block reader, a metadata block writer, a metadata reader, and/or a metadata writer for performing operations on metadata in an image file without need of a decoder and/or encoder.

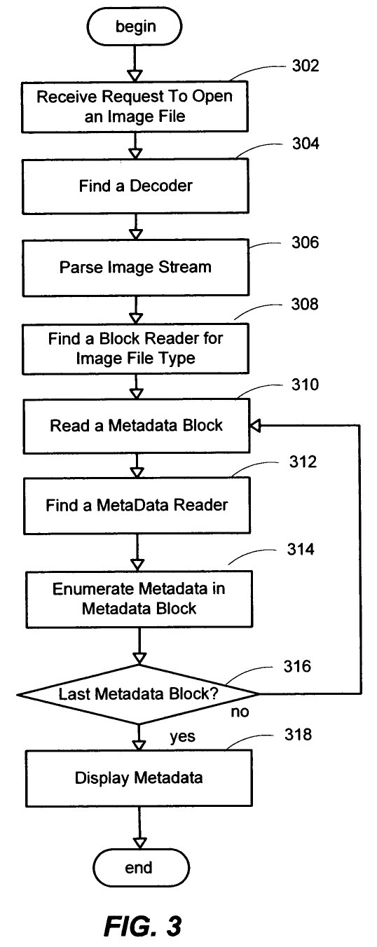

FIG. 3 presents a flowchart generally representing exemplary steps undertaken in one embodiment for reading metadata in an image file. Those skilled in the art will appreciate that an implementation may choose to perform these steps in a different order or may choose to perform only some of these steps for purposes of efficiency or flexibility, while achieving the same effect and without departing from the scope of the present invention. At step 302, a request to open an image file may be received. A decoder may then be found for reading the image file at step 304. There may be a decoder provided for each type of image file supported by the computer system. Based upon the type of image file, a decoder provided for that image type may be instantiated.

Once a decoder may be found, the image stream stored in the file image may be parsed at step 306, for instance, by the instantiated decoder to confirm that the decoder may be able to read the metadata in the image file. At step 308, a metadata block reader may be found for the image file. In one embodiment, the decoder may use an API to find and instantiate the metadata block reader based upon the type of the image file. Next, a metadata block may be read at step 310 from the image file by a metadata block reader, and, then, a metadata reader that may decipher the metadata items in the metadata block may be found at step 312. For instance, a metadata reader may be registered in an embodiment by a metadata GUID that may identify the type of metadata block that it may decipher. In one embodiment, an unknown reader for the metadata block may be instantiated for the metadata block, if a reader cannot be found for a metadata block.

The metadata in the metadata block may then be enumerated at step 314. Once the metadata in the metadata block may be enumerated, it may be determined at step 316 if the last block of metadata may have been read from the image file. If not, then another metadata block may be read by returning to step 310. For each metadata block in the image file, steps 310 to 314 may be performed. Thus, each metadata block may be read, a metadata reader found, and the metadata in the metadata block may be enumerated in an embodiment. If it may be determined at step 316 that the last metadata block has been read, then the metadata enumerated may be displayed at step 318 or may used for any other purpose by an application, and processing for reading the metadata from the file may be finished.

In one embodiment, an acylic tree representing the metadata hierarchy may be constructed by using the steps described in FIG. 3. Each metadata block may represent a node in the tree and a nested metadata block within a metadata block may represent a child of the node representing the metadata block in the tree. There may be a metadata reader associated with each metadata block represented by a node in the tree. By walking the tree using an inorder traversal, the metadata within an image file may be completely enumerated by requesting the metadata reader associated with the metadata block at each node to enumerate the properties of the metadata block. In one embodiment, the tree may be built lazily so that the properties for a metadata block may not be read until the properties need to be read. For example, a metadata item such as “Author” may be requested. While lazily building the tree, a metadata reader associated with a node representing a metadata block at the second level of the tree may enumerate the property for “Author”. If no other properties may be subsequently requested, then the image file does not need to be further read nor do any other metadata blocks need to be deciphered.

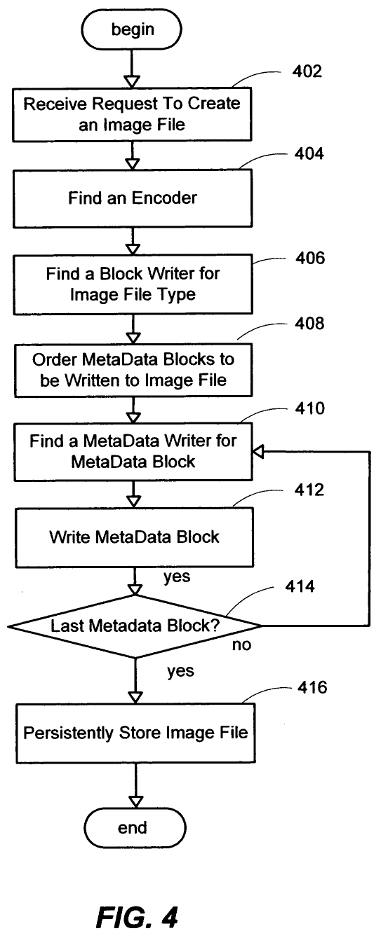

FIG. 4 presents a flowchart generally representing exemplary steps undertaken in one embodiment for writing metadata in an image file. At step 402, a request to create an image file may be received. An encoder may then be found for writing metadata in the image file at step 404. There may be an encoder provided for each type of image file supported by the computer system. Based upon the type of image file, an encoder provided for that image type may be instantiated.

Once an encoder may be found, a metadata block writer may be found for the image file at step 406. In one embodiment, the encoder may use an API to find and instantiate the metadata block writer based upon the type of the image file. Next,an ordering of metadata blocks that may be written according to a format of the image file may be determined at step 408, for instance, by the instantiated encoder.

Then, a metadata writer may be found that may write the metadata items in the metadata block may be found at step 410. In an embodiment, an API may be invoked for finding and instantiating a metadata writer for the metadata block. The metadata block may then be written at step 412 in a metadata stream for the image file. Once the metadata block may be written in the metadata steam for the image file, it may be determined at step 414 if the last block of metadata in the ordering of metadata blocks to be written to the metadata stream has been written to the metadata stream for the image file. If not, then another metadata writer may be found by returning to step 410. For each metadata block in the ordering of metadata blocks to be written to the metadata stream for the image file, steps 410 to 412 may be performed.

Thus for each metadata block in the ordering, a metadata reader may be found, the metadata may be written in the metadata block, and the metadata block may be serially written into the metadata stream for the image file in an embodiment. If it may be determined at step 414 that the last metadata block in the ordering has been written, then the image file including the written metadata stream may be persistently stored at step 416 or may used for any other purpose by an application, and processing for writing the metadata in an image file may be finished.

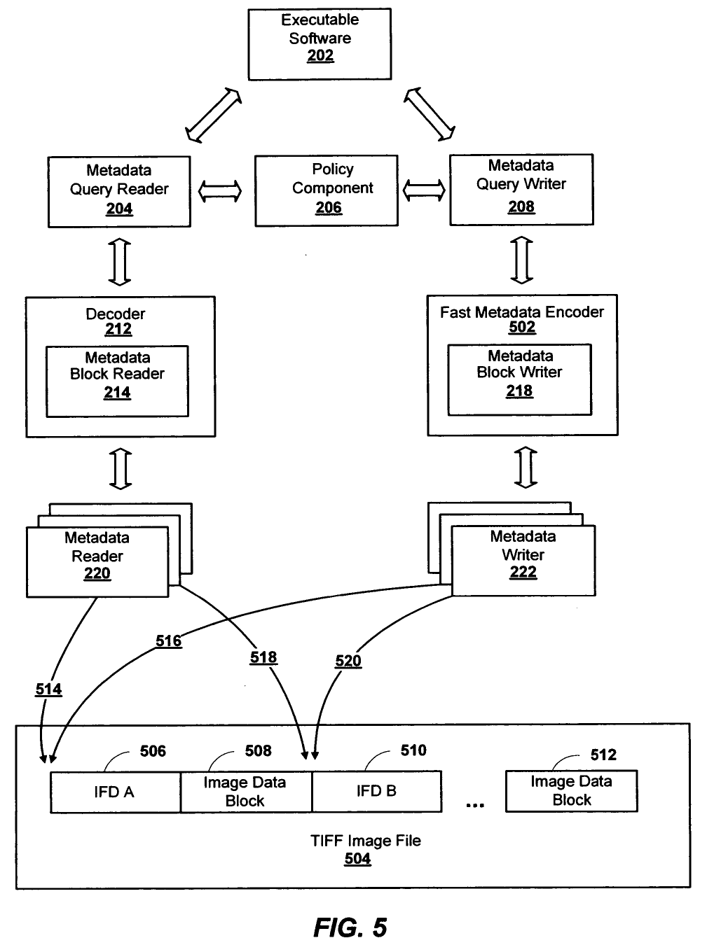

FIG. 5 presents a block diagram generally representing an exemplary architecture of system components in one embodiment of an extensible metadata architecture for fast writing of metadata in an image file. In this embodiment, in-place editing of metadata items in a metadata block may be implemented by first using a metadata block reader to read a metadata block from an image file and then using a fast metadata block writer to perform in-place editing of metadata items in the metadata block for writing back to the image file. As used herein, in-place editing of metadata may mean re-encoding a metadata block within an image stream.

Accordingly, executable software 202 may request that the metadata query reader 204 read a metadata item from an image file, such as TIFF image file 504 illustrated in FIG. 5. If the request received by the metadata query reader may not be a fully qualified query for the metadata item, policy component 206 may resolve the query so that it may be a fully qualified query for the metadata item. A decoder that may be provided for a TIFF image type, such as decoder 212, may then be instantiated.

Metadata block reader 214 operably coupled to decoder 212 may find and instantiate one or more metadata readers 220 for parsing metadata blocks to decipher the metadata items in each metadata block. For example, one metadata reader able to parse metadata block 506 may be instantiated and may establish a reference 514 that may point to metadata block 506. Metadata block 506 may represent an image file directory (IFD), labeled IFD A, within TIFF image file 504 and may provide metadata information requested about image data block 508. For example, image data block 508 that may represent a page of a facsimile and the metadata item requested by executable 202 may be the Author of the facsimile image.

Upon receiving the metadata item requested, the executable may request that metadata query writer 208 change the name of the Author for the page of the facsimile. A fast metadata encoder 502 may be instantiated in order to perform in-place editing of metadata block 506. Fast metadata encoder 502 may be an encoder provided for writing metadata to a TIFF image file. The fast metadata encoder 502 may include a metadata block writer 218 that may be operably coupled to one or more metadata writers 222.

To do so, the metadata block writer 218 may use the list of metadata readers 220 operably coupled to the metadata block reader 214 to instantiate corresponding metadata writers 222 initialized with a reference to each metadata block. For example, a metadata writer, which may correspond to the metadata reader with the reference 514 to metadata block 506, may be instantiated and initialized with reference 516 pointing to metadata block 506. And another metadata writer, which may correspond to the metadata reader with the reference 518 to metadata block 510, may be instantiated and initialized with reference 520 pointing to metadata block 510. In this way, the metadata block writer 218 may identify and add a metadata writer 222 for metadata block 506 which may include the metadata item of Author requested to be changed for the image block data 508 within the TIFF image file 504. As part of instantiating metadata writer 222, reference 516 may be established to metadata block 506 to perform in-place editing to change the metadata item of Author within the TIFF image file stream 504.

In one embodiment, a mechanism may be provided for adding padding to a metadata block to allow sufficient space for a fast metadata encoder to write a metadata block with additional metadata, rather than having to write an entire image file. For example, padding may be added when encoding to an image file. Accordingly, an executable, such as an application program, may set an amount of padding by using the query language to identify a location within the metadata hierarchy to add padding. For instance, in the case of a TIFF image, an application may set a metadata item, such as “/ifd/PaddingSchema:padding” with the value of 4096 to allocate 4K of padding. Then, when a metadata writer may write to an image file, it may include 4K of additional space for use in future metadata updates.

In various embodiments, a tracking mechanism may also be used to record free space that may be made available when a metadata item may be removed. For example, free space may be recorded in a data structure as an offset and size of deleted data. When new metadata may be added during in-place editing, the metadata may be written in available free space that may be allocated from the data structure.

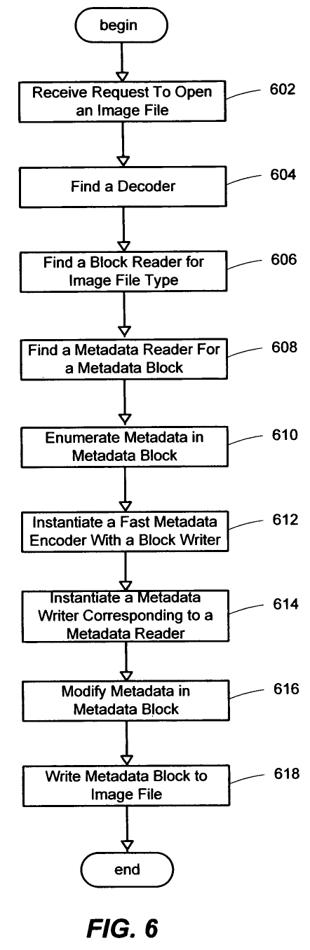

FIG. 6 presents a flowchart generally representing exemplary steps undertaken in one embodiment for fast writing of metadata in an image file. At step 602, a request to open an image file may be received. A decoder may then be found for reading the image file at step 604. Based upon the type of image file, a decoder provided for that image type may be instantiated. Once a decoder may be found, a metadata block reader may be found for the image file. Next, a metadata block may be read from the image file by a metadata block reader, and, then, a metadata reader that may decipher the metadata items in the metadata block may be found at step 608 and may be instantiated. The metadata in the metadata block may then be enumerated at step 610 by the metadata reader.

Once the metadata in the metadata block may be enumerated, a fast metadata encoder with a metadata block writer may then be instantiated for writing metadata in the image file at step 612. A metadata writer corresponding to the metadata reader may be instantiated at step 614. In one embodiment, the metadata block writer of the fast metadata encoder may use the list of metadata readers operably coupled to the metadata block reader to instantiate corresponding metadata writers initialized with a reference to each metadata block referenced by each respective metadata reader. After a metadata writer may be instantiated with a reference to a metadata block, metadata may be modified in the metadata block at step 616. Finally, the modified metadata block may be written to the image file that may be persistently stored, and processing for fast writing of metadata in an image file may be finished.

Advantageously, the system and method for fast writing of metadata in an image file may allow in-place editing of metadata without using a separate image stream for writing modified metadata to an image file. Instead, a fast metadata encoder may use the same image stream read by a decoder. In one embodiment, a mechanism may be provided for adding padding to a metadata block to accommodate metadata that may be later added. This may also allow sufficient space for a fast metadata encoder to simply write a metadata block with additional metadata, rather than having to write an entire image file.

Furthermore, the system and method support a query language so that a metadata query reader and a metadata query writer may receive a query string and resolve the string to a specific location within a metadata hierarchy. In an embodiment, the query string may be of a list of names identifying a navigation path through the metadata hierarchy. Each name may refer to a metadata namespace which may be a specific metadata block within the hierarchy. For example, the query string, “/ifd/exif/xmp/exif:Author”, may correspond to the navigation path=>“IFD reader”→“EXIF reader”→“XMP reader”→property “Author” in “exif” schema. By following the navigation path, the value for the property of “Author” may be retrieved within the “exif” schema. In one embodiment, each metadata namespace may also uniquely identified by a metadata global unique identifier (GUID) which may be used in place of the namespace name, “/{GUID}/[n]{GUID}/{GUID}:Value”, for example.

If the query string specified does not correspond to a fully qualified location, then the request may be resolved by the policy component which may map a keyword to a fully qualified location. The policy component may also be responsible for mapping high level requests for metadata to specific locations within the underlying metadata hierarchy. For instance, there may be several places within a metadata hierarchy where a metadata item may be stored. For example, “Author” may be stored in several different metadata blocks. The policy component may apply a set of rules, such as a preferred order of locations specified for a particular metadata item, to map a request for a metadata item to a specific location within the metadata.

As can be seen from the foregoing detailed description, the present invention provides an improved system and method for an extensible metadata architecture for digital images. The system and method may advantageously allow the addition of a new metadata type to be added to an image file, and new metadata readers and writers may be easily added for decoding and encoding metadata in an image file associated with the new metadata type. Moreover, an enumerated metadata item may be changed using a fast metadata encoder to perform in-place editing of the metadata. The present invention may also support a query language for mapping high level requests for metadata items to specific locations within the metadata hierarchy. As is now understood, the system and method thus provide significant advantages and benefits needed in contemporary computing.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention. For example, the present invention may be used for any type of multimedia content that may include metadata such as digital video, audio, and so forth.

What is claimed is:

1. A computer system for manipulation of metadata for digital multimedia content, comprising:
executable software code for requesting an operation to be performed on metadata in a file including multimedia content;
a decoder operably coupled to the executable software code, the decoder having an operably coupled metadata block reader for identifying a metadata block in the file and associating a metadata reader with the metadata block;
a metadata reader operably coupled to the metadata block reader for enumerating metadata in the metadata block;
an encoder operably coupled to the executable software code, the encoder having an operably coupled metadata block writer for associating a metadata writer with the metadata block; and
a metadata writer operably coupled to the metadata block writer for writing metadata into the metadata block.

2. The system of claim 1 further comprising a metadata query reader operably coupled to the executable software code for receiving a request for performing an operation on the metadata in the file.

3. The system of claim 1 further comprising a metadata query writer operably coupled to the executable software code for receiving a request for performing an operation on the metadata in the file.

4. The system of claim 2 further comprising a policy component operably coupled to the metadata query reader for resolving a query for an item of the metadata in the file.

5. The system of claim 1 further comprising the file operably coupled to the metadata reader, the file having one or more metadata blocks.

6. The system of claim 1 further comprising a file operably coupled to the metadata writer, the file having one or more metadata blocks.

7. A computer-readable medium having computer-executable components comprising the system of claim 1.

8. A method for manipulating metadata for digital multimedia content, comprising the steps of:
receiving a request to open a file including multimedia content;
finding a decoder for the type of the file;
finding a block reader for the type of the file;
finding a metadata reader for a metadata block in the file; and
enumerating the metadata in the metadata block in the file.

9. The method of claim 8 further comprising parsing a stream of content from the file.

10. The method of claim 8 wherein finding the metadata reader comprises reading the metadata block and associating the metadata reader with the metadata block.

11. The method of claim 8 further comprising finding additional metadata readers for additional metadata blocks in the file.

12. The method of claim 11 wherein finding the additional metadata readers for the additional metadata blocks in the file comprises reading the additional metadata blocks and associating the additional metadata readers with the additional metadata blocks.

13. The method of claim 11 further comprising enumerating the metadata in the additional metadata blocks in the file.

14. A computer-readable medium having computer-executable instructions for performing the method of claim 8.

15. A method for manipulating metadata for digital multimedia content, comprising the steps of:
receiving a request to create a file including multimedia content;
finding an encoder for the type of the file;
finding a block writer for the type of the file;
finding a metadata writer for a metadata block to be written in the file; and
writing metadata in the metadata block in the file.

16. The method of claim 15 further comprising ordering metadata blocks to be written to the file.

17. The method of claim 15 wherein finding the metadata writer for the metadata block comprises associating the metadata writer with the metadata block to be written in the file.

18. The method of claim 15 further comprising finding additional metadata writers for additional metadata blocks to be written in the file.

19. The method of claim 18 wherein finding the additional metadata writers for the additional metadata blocks to be written in the file comprises associating the additional metadata writers with the additional metadata block to be written in the file.

20. The method of claim 19 further comprising writing metadata in the additional metadata blocks in the file.
